(19) United States
(12) Patent Application Publication
(10) Pub. No.: US 2016/0018306 A1
(43) Pub. Date: Jan. 21, 2016

(54) Method and Apparatus for Direct-Acting Wide Frequency Range Dynamic Mechanical Analysis of Materials

(71) Applicant: Lecon Woo, Libertyville, IL (US)

(72) Inventor: Lecon Woo, Libertyville, IL (US)

(21) Appl. No.: 14/333,557

(22) Filed: Jul. 17, 2014

(51) Int. Cl. G01N 3/02; G01N 3/20; G01N 3/08

(52) U.S. Cl. CPC G01N 3/02; G01N 3/08; G01N 3/20

(57) ABSTRACT

An improved method and apparatus for direct-acting dynamic mechanical analysis that accomodates sample distortion due to environmental (e.g., temperature) variation.

### CROSS REFERENCE TO RELATED APPLICATIONS

This application is a continuation-in-part of application Ser. No. 13/595,193, filed Aug. 27, 2012, which claims the benefit under 35 U.S.C. §119(e) of U.S. provisional application No. 61/528,215, filed Aug. 27, 2011.

### BACKGROUND

Dynamic mechanical analysis (DMA) is a branch of rheology in which a sample is subjected to time-varying mechanical excitation, and its response measured. DMA has proven to be of great utility for studying materials relaxation processes arising from micro-structural components including polymers' main chain linkage, side group moiety, or domain structures in inorganic polymers and metals; in addition, it provides critically important design engineering data including modulus, upper use temperature, as well as the kinetics of curing for curing systems.

Methods for dynamic mechanical analysis can be divided into resonant and driven methods. In resonant methods, the sample is incorporated into a resonant vibration system and set into motion at the system's resonant frequency. Useful methods include the vibrating reed, torsion pendulum, or the later modified method of torsional braid analysis by Gillham et al.(see for example Polymer Engineering and Science Vol. 11(4):295-304 (1971), incorporated herein by reference in its entirety), and the compound resonant apparatus by Woo and McGhee (U.S. Pat. No. 4,034,602, incorporated herein by reference in its entirety). A sample's elastic and loss modulus are calculated from the resonant frequency the system and tan delta, where delta is the loss angle between the elastic and loss moduli, or by using the method of Woo (U.S. Pat. No. 4,170,141, incorporated herein by reference in its entirety). As a rule, the resonant method is somewhat limited in accuracy because the sample's material parameters are calculated from the behavior of the compound system. Furthermore, activation enthalpy analysis presents challenges, due to the requirements of simultaneously varying temperature and frequency.

With the driven method, the sample is typically subjected to sinusoidal excitation, either in stress, or strain, and the corresponding material response in strain or stress is detected. The phase angle theta is either directly measured or measured by deconvolution. The driven method is further divided into modes where the excitation and response measuring means are located on different sides or same side of the sample. In the Takeda design (Seiko, U.S. Pat. No. 5,154,085, incorporated herein by reference in its entirety), the stress exciter and the displacement (strain) sensor are located on one side of the sample, whereas in the Buck design (U.S. Pat. No. 6,389,906, incorporated herein by reference in its entirety), the strain exciter and the stress sensor are located on opposite sides of the sample. A recent publication by J. Capogagli et al., incorporated herein by reference in its entirety, describes an instrumental technique capable of up to 11 decades of frequency coverage (Rheol Acta (2008) 47:777-786), using a fixed-free torsion pendulum geometry where an embedded rare earth magnet on the sample generates dynamic torque on the sample from a non-contacting electromagnetic field from a solenoid coil carrying the AC current. As described by Capogagli et al., such non-contacting analysis is limited to very rigid samples due to creep effects for semi-rigid samples.

Although the art of DMA has advanced to a very high level, there are still many areas where further improvements are needed, including reliable direct measurement at high frequencies. Furthermore, improvements are needed in the ability to handle samples of very small size.

Additionally, one of the major limitations of many commercial instruments is the inability to accommodate sample expansion and contraction over wide temperatures. A well-known challenge for all instruments is the alteration of a sample during a temperature scan, including rubber-to-glass transition and softening, due to mechanical excitations imposed by the instrument. U.S. Pat. Nos. 5,154,085 and 6,880,385 by Esser, et al., represent some of the past efforts to overcome sample expansion, relaxation and softening effects. Over the temperature span of a typical experiment between −150° C. and 200° C., the sample starts from a state far below the glass transition and ends in a state far above the glass transition. During the course of this alteration, the sample modulus can change over a thousand-fold, and the sample dimension can change by as much as 5%. In addition, built-in stresses may relax and cause the sample to distort considerably from its original shape. Thus, there is a need in the prior art for apparatuses and methods capable of accommodating sample alteration across a range of temperatures.

### SUMMARY OF THE INVENTION

The present disclosure provides embodiments of an apparatus that accurately performs dynamic mechanical analysis (DMA) in the presence of sample alteration induced by environmental variation. Such alterations include, but are not limited to thermal expansion, and and relaxation of internal stresses near the glass-rubber transition.

In some aspects, the disclosure provides methods for dynamic mechanical analysis of a sample comprising: a) contacting the sample to a dynamic displacement transducer; b) subjecting the sample to controlled variation of one or more environmental variables; c) subjecting the sample to a dynamic displacement produced by the dynamic displacement transducer; d) contacting the sample to a stress transducer, such that the sample experiences a strain; e) taking a measurement representative of the response of the sample to the strain; f) releasing the contact between the sample and the stress transducer; and g) iterating steps b) through f), thereby obtaining a series of measurements across a range of said one or more environmental variables.

In some aspects, the disclosure provides methods for dynamic mechanical analysis of a sample comprising: a) contacting the sample to a dynamic displacement transducer; b) subjecting the sample to controlled variation of one or more environmental variables; c) subjecting the sample to a dynamic displacement produced by the dynamic displacement transducer; d) contacting the sample to a stress transducer, such that the sample experiences a strain; e) taking a measurement representative of the response of the sample to the strain; f) releasing the contact between the sample and either the dynamic displacement transducer or the stress transducer; and g) iterating steps b) through f), thereby obtaining a series of measurements across a range of said one or more environmental variables.

In some aspects, the disclosure provides methods for dynamic mechanical analysis of a sample comprising: a) contacting the sample to a dynamic displacement transducer; b) subjecting the sample to controlled variation of one or more environmental variables; c) subjecting the sample to a dynamic displacement produced by the dynamic displacement transducer; d) contacting the sample to a stress transducer, such that the sample experiences a strain; e) taking a measurement representative of the response of the sample to the strain; f) releasing the contact between the sample and the dynamic displacement transducer; and g) iterating steps b) through f), thereby obtaining a series of measurements across a range of said one or more environmental variables.

In some embodiments, contacting the sample to a stress transducer comprises bringing the sample in contact with the stress transducer, then advancing the sample towards the stress tranducer by an additional finite measure, prior to taking the measurement of step e. This finite measure can be computed as a percentage of the sample length, e.g., 1%, 2%, 3%, 4%, 5%, 6%, 7%, 8%, 9%, or 10% of the sample length.

In some embodiments, contacting the sample to a stress transducer comprises employing software means to determine contact between the stress transducer and the sample.

In some embodiments, the contact between the sample and stress transducer is released by changing the position of the sample relative to the stress transducer. In some embodiments, the contact between the sample and stress transducer is released by changing the position of the dynamic displacement transducer relative to the stress transducer. In some embodiments, the contact between the sample and dynamic displacement transducer is released by changing the position of the sample relative to the dynamic displacement transducer.

In some embodiments, each of the one or more environmental variables is selected from the group consisting of: temperature, time, electric field, and magnetic field. In some embodiments, one of the one or more environmental variables is temperature.

The methods may further comprise measuring the sample length, using intermittent minimal contact force. The methods may further comprise calculating a coefficient of thermal expansion of the sample.

In some embodiments, the sample is not in simultaneous contact with both the dynamic displacement transducer and the stress transducer during the controlled variation of one or more environmental variables. In some embodiments, the sample undergoes a phase change or chemical transformation during the controlled variation of one or more environmental variables.

In some aspects, the disclosure provides an apparatus for dynamic mechanical analysis comprising: a) means for controlling variation of one or more environmental variables; b) a dynamic displacement transducer; c) a stress transducer; d) measuring means for detecting a signal from the stress transducer representative of the response of a sample; e) sample holding means, permitting contact between the sample and one, both, and neither of the dynamic displacement transducer and stress transducer; and f) computer-implemented means for modulating contact between the sample and the stress transducer for each measurement cycle.

In some aspects, the disclosure provides methods for dynamic mechanical analysis of a sample comprising: a) contacting the sample to a stress transducer; b) subjecting the sample to controlled variation of one or more environmental variables; c) contacting the sample to a dynamic displacement transducer coupled to an actuator; d) subjecting the sample to a dynamic displacement produced by the dynamic displacement transducer, such that the sample experiences a strain; e) taking a measurement representative of the response of the sample to the strain; f) releasing the contact between the sample and the dynamic displacement transducer; and g) iterating steps b) through f), thereby obtaining a series of measurements across a range of said one or more environmental variables; wherein, for each measurement cycle, motion of the actuator alternates the position of contact between the dynamic displacement transducer and the sample between two opposing sides, thereby tending to restore distortion of the sample caused by contact with the dynamic displacement transducer from the previous cycle.

In some aspects, the disclosure provides methods for dynamic mechanical analysis of a sample comprising: a) contacting the sample to a stress transducer; b) subjecting the sample to controlled variation of one or more environmental variables; c) contacting the sample to a dynamic displacement transducer coupled to an actuator; d) subjecting the sample to a dynamic displacement produced by the dynamic displacement transducer, such that the sample experiences a strain; e) taking a measurement representative of the response of the sample to the strain; f) releasing the contact between the sample and the dynamic displacement transducer; and g) iterating steps b) through f), thereby obtaining a series of measurements across a range of said one or more environmental variables; wherein, for each measurement cycle, motion of the actuator alternates the position of contact between the dynamic displacement transducer and the sample between two opposing sides, thereby tending to maintain the original shape of the sample.

In some aspects, the disclosure provides methods for dynamic mechanical analysis of a sample comprising: a) contacting the sample to a stress transducer; b) subjecting the sample to controlled variation of one or more environmental variables; c) contacting the sample to a dynamic displacement transducer coupled to an actuator; d) subjecting the sample to a dynamic displacement produced by the dynamic displacement transducer, such that the sample experiences a strain; e) taking a measurement representative of the sample response to the strain; f) releasing the contact between the sample and the dynamic displacement transducer; and g) iterating steps b) through f), thereby obtaining a series of measurements across a range of said one or more environmental variables; wherein, for each measurement cycle, motion of the actuator reverses the direction of net force exerted by the the dynamic displacement transducer on the sample, thereby tending to restore distortion of the sample caused by contact with the dynamic displacement transducer from the previous cycle.

In some aspects, the disclosure provides methods for dynamic mechanical analysis of a sample comprising: a) contacting the sample to a stress transducer; b) subjecting the sample to controlled variation of one or more environmental variables; c) contacting the sample to a dynamic displacement transducer coupled to an actuator; d) subjecting the sample to a dynamic displacement produced by the dynamic displacement transducer, such that the sample experiences a strain; e) taking a measurement representative of the response of the sample to the strain; f) releasing the contact between the sample and the dynamic displacement transducer; and g) iterating steps b) through f), thereby obtaining a series of measurements across a range of said one or more environmental variables; wherein, for each measurement cycle, motion of the actuator reverses the direction of net force exerted by the the dynamic displacement transducer on the sample, thereby tending to maintain the original shape of the sample.

In some aspects, the disclosure provides an apparatus for dynamic mechanical analysis comprising: a) means for controlling variation of one or more environmental variables; b) a dynamic displacement transducer capable of contacting a sample from two opposing sides; c) a stress transducer; d) measuring means for detecting a signal from the stress transducer representative of the response of a sample; e) sample holding means, permitting contact between the sample and one, both, and neither of the dynamic displacement transducer and stress transducer; f) computer-implemented means for modulating contact between the sample and the dynamic displacement transducer for each measurement cycle; and g) means to alternate the position of contact between the dynamic displacement transducer and the sample with each measurement cycle, thereby tending to maintain the original shape of the sample.

### BRIEF DESCRIPTION OF DRAWINGS

FIG. 1 provides an illustration of a preferred embodiment of the disclosure;

FIG. 2 provides a schematic illustrating a three-point bending geometry mode of analysis;

FIG. 3 provides a schematic illustrating an additional three-point bending geometry mode of analysis;

FIG. 4 provides a schematic illustrating a tensile testing geometry mode of analysis;

FIG. 5 provides data showing 20 kHz analysis of displacement (upper panel) and stress (lower panel);

FIG. 6 provides change in length over length (dL/L) data for 15% PVC thermal expansion;

FIG. 7 provides complex modulus E* data from a PVC sample of about 36% plasticizer at different frequencies and precisely known compressive strains; and

FIG. 8 provides an activation enthalpy plot of a PVC sample of about 15% plasticizer content covering a very broad frequency range.

FIG. 9 provides a schematic illustrating an actuator mechanism for maintaining sample shape. A) The sample is not in contact with the displacement transducer. B) The lower part of the sample contacts the displacement transducer. C) The upper part of the sample contacts the displacement transducer.

### DETAILED DESCRIPTION

The present disclosure relates to the problem that a sample's alteration during the dynamic measurements greatly influences the measured quantities, especially at higher frequencies. Methods of the disclosure are useful in performing dynamic mechanical analysis (DMA) characterizing the visco-elastic behavior of a sample subjected to variation in, e.g., temperature, excitation frequencies, phase changes, and chemical transformation of the sample.

In some embodiments, a sample is subjected to varying temperature, and temperature-dependent measurements are made.

Methods of the present disclosure address the problem of sample alteration by subjecting the sample to environmental variation while the sample is physically unconstrained. By releasing the contact between the sample and either the dynamic displacement transducer or the stress transducer, the sample is not simultaneously in contact with both the dynamic displacement transducer and the stress transducer and is thus physically unconstrained.

The release of contact between the sample and either the dynamic displacement transducer or the stress transducer is performed at the end of each measurement cycle. As used herein, a measurement cycle refers to an iteration of the steps of the method, wherein a sample is subjected to controlled variation of one or more environmental variables, subjected to a dynamic displacement produced by a dynamic displacement transducer, contacted to a stress transducer, and a measurement of sample's response to the resulting strain is made, prior to release of the contact between the sample and the stress transducer. As a result of the iterative process of releasing contact, varying the environment, and re-engaging contact for measurement, the measurements are adjusted at each cycle for sample alteration as a result of the environmental variation.

In typical embodiments, a computer is utilized to control and sequence hardware motion control, synthesizer frequency and amplitude, data logging, and data processing. In some embodiments, software detects the instance in time and Z-axis position where the sample and the stress transducer first come into contact using a a pre-determined threshold amplitude at the frequency of interest. Upon entry into the subroutine to detect the onset of contact between sample and the stress transducer, the computer can command the Z-axis motor to advance at a preset speed and periodically update the Z-axis position to a high degree of resolution. Meanwhile, the output of the tracking amplifier for the stress channel at the frequency of interest can be constantly compared with a pre-set threshold value. When the threshold is reached, the computer can pause the Z-axis advance, store the Z-positon value and compute the sample dimension at the point of contact detection before exiting the subroutine. Such methods allow sensitive detection of contact force, which in turn allows, e.g., accurate determintaion of sample length with minimal contact force.

In some embodiments, the disclosure provides an apparatus comprising a first a rigid frame which serves as the mechanical reference point for both sample and the sensors. Mounted onto the rigid frame is an electronically controlled mechanical linear stage of very high rigidity and capable of mechanical resolution better than 1 micron. The electronic linear stage may work optionally in combination with a manually actuated mechanical stage to provide coarse movements. The position of the stage is monitored by a low frequency displacement sensor such as, e.g., a linear variable differential transformer (LVDT) or an optical encoder. On the electronic stage, a very high rigidity (minimum 40 N/micron) actuator capable of a minimum of 5 micron stroke and resolution of greater than 5 nanometers is rigidly attached. In some embodiments, the actuator is of the giant magneto-strictive type where typically a Terfenol-D® or similar ceramic rod undergoes rapid dimensional changes in response to an axial external magnetic field from a solenoid coil windings. Since the Terfenol-D® rare-earth ceramic is extremely high in modulus on the order of 30 GPa, the actuator is of very high rigidity and capable high frequencies (U.S. Pat. No. 4,818,304 assigned to Iowa State University Research Foundation). In some embodiments, the actuator is of a piezoelectric ceramic stack construction, wherein a plurality of piezoelectric ceramic wafers are electrically connected in parallel and bonded mechanically in series to provide much larger strokes and very high rigidity. Some designs of these high force high rigidity piezo actuators are also fitted with an integral displacement sensor, either a strain gage, or a capacitive type, to provide instantaneous positional data output for the actuator (one commercial example is made by Physik Instrumente). Actuators are currently used in electro-optical devices for astronomy and nanometer scale semiconductor fabrications. In some embodiments, a Physik Instrumente P-239 series commercial actuator, exhibiting a maximum stroke of 60 microns and rigidity of 40 N/micron, is employed.

Rigidly attached to the actuator is a sample platform with low mass yet very high rigidity. The platform can be of various designs to accommodate different sample testing modes and geometries, including, but not limited to, rectangular cylinder, circular cylinder, annular liquid pumping, and three point bending. Adjacent to the platform, but not in mechanical contact with the platform, is a non-contact position sensor capable of sensing the position of the top surface of the platform along the actuating axis with spatial resolution of better than 300 nanometers and frequency ranges from DC (static) to greater than 20 kHz. Transducers meeting these requirements include capacitive, optical, or inductive sensors. For example, the Keyence LKG5000 series of non-contact laser sensors are capable of 392 kHz sampling frequency, and up to 0.005 micron spatial repeatability. Similarly, the Keyences EX-200 series of inductive sensors are capable of spatial resolution of 0.3 micron and upper frequency limit of greater than 10 kHz. And as another example, ADE Technologies of Westwood Mass. has an ADE 5810 series capacitive sensors capable of 20 nm resolution and 100 kHz bandwidth. In some embodiments, the displacement sensor is a Keyence EX-200 series non-contact inductive displacement sensor with a sensitivity of about 5 mV/ micron and frequency limits from DC to about 20 kHz.

Axially aligned with the platform and the sample, is a force coupling member of very high rigidity and capable of wide temperature ranges. This member can be fabricated from high temperature fiber reinforced thermoset polymer composite, ceramic, or titanium alloy.

Connecting the force coupling member is a very rigid, low compliance, load cell fasting to the rigid reference frame and capable of very high frequency operations. Optionally, a lower frequency load call can be connected in series to provide static (zero frequency) data. In typical embodiments, a Kistler 912 H quartz load cell with first resonance frequency of greater than 60 kHz , and rigidity of 75 N/micron and a Kistler 5004 dual mode amplifier can be used. In some embodiments, a low impedance Kistler 9712A5 load cell having rigidity of 910 N/ micron and a time constant of 260 seconds can be used to provide exceptional low frequency capability and allow near-static operations.

Enclosing the sample platform, the sample, force coupling members, is an environmental chamber capable of the broad temperature range and temperature controlling means and liquid nitrogen gas exchange means for cryogenic temperatures.

Ways by which excitation is applied to the sample can be direct and indirect. In the direct method, the sample is driven by a dynamic excitation transducer in direct contact, where the indirect method the sample is excited via a non-contact field such as electromagnetic field. In some embodiments, excitation is applied by direct contact.

After a sample 5 is inserted and aligned in position on the sample platform, the environmental enclosure is closed while the upper surface is disengaged from contacting the stress transfer member 6 and the stress sensor 7. The sample is then allowed to equilibrate at the experimental temperature and allowed to expand without any externally exerted stress or strain. After the equilibration period, the dynamic displacement excitation and Z axis stage is activated and the actuator platform and sample assembly is programmed to approach the upper assembly with a controlled rate while the output of the stress channel is continually monitored. When the sample's upper surface first make contact with the stress transfer member 6 and the stress sensor 7, a sharp upturn in signal amplitude at the driven frequency is detected. The actual sample length at the position of first contact is recorded and stored for experimental coefficient of expansion calculations. After the first contact, the Z-Axis control further advances the sample to multiple, precisely set strain levels. At each strain level, a complete frequency scan covering the entire desired frequency coverage is initiated and data recorded. It is noted that depending on the chosen geometry and mode of operation, either the illustrated compressive, or alternate tensile, or shear strains can be set at measurement points. At the completion of the frequency scan for all strain levels, the Z-axis stage is retracted until the sample is disengaged from contacting both the platform and the stress transfer member and the stress sensor until the next measurement cycle after temperature ramping.

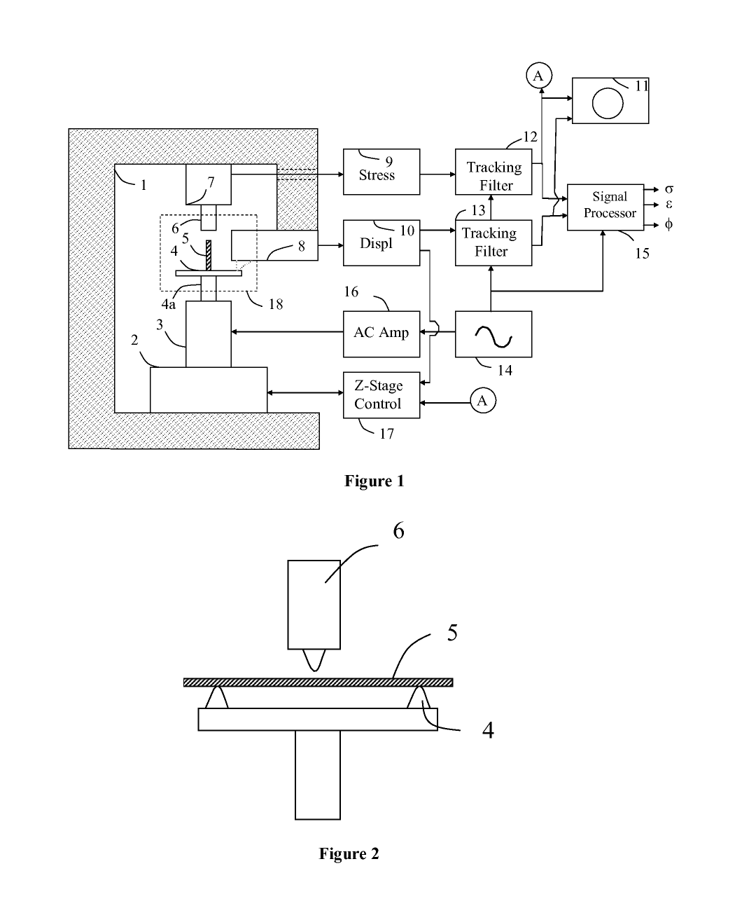

FIG. 1 shows a schematic of an embodiment of the disclosure, partially in cross-sectional view and partially in block diagram view. A rigid frame 1 allows mounting all mechanical components, and attached to the base of the frame is a precision Z-axis electronically controlled stage 2, and on the top surface of the stage, a high rigidity, high frequency actuator 3 is attached. The actuator is connected to a sample carrying platform 4 integral with an insulating member 4a. Near the center of the platform and aligned along the central axis of the apparatus is a sample 5 shown in the elongated cylindrical form. Attached on the upper frame and aligned with the sample and the actuator axis is a stress transfer member 6, similar in construction as 4a, and between the frame and the stress transfer member is a rigidly mounted stress transducer capable of very high frequencies 7. It is noted that as illustrated, the upper surface of the sample is not in contact with the stress transfer member and the stress transducer. Adjacent to the sample platform, also rigidly mounted to the frame is a non-contact displacement transducer 8, as illustrated, is a high frequency optical transducer capable of both static displacement and dynamic measurements. The sample and adjacent components are enclosed in an environmental enclosure 18 capable of wide temperature operations from −196° C. to about 500° C. typical of dynamic mechanical analyzers.

The outputs of the stress and displacement transducers are fed to amplifiers 9 and 10 respectively and displayed in real time on an electronic oscilloscope 11. The outputs of stress and displacement amplifiers are also fed to tracking amplifiers 12 and 13 with the center frequencies provided by the sinusoidal waveform synthesizer 14. The outputs of the tracking filters are fed into a digital signal processor 15 along with the reference from the synthesizer 14. The signal processor provides the usual phase detection and de-convolution functions and produces sample stress, strain and phase angle as output. The tracking filter, amplifier, and phase detection function can be fulfilled by a signal processer known as Lock-In Amplifier such as Stanford Research model SR-530. The sinusoidal signal from the synthesizer 14 is also provided to an amplifier 16 properly configured to drive the actuator. The static displacement output from the displacement amplifier 10 and the output of the stress amplifier 9 are fed to a Z-axis stage control unit 17. The Z axis stage control, based on points on the measurement cycle, provides the necessary Z-Axis movements in detecting the first contact between sample and the stress transfer member and the stress transducer, and position the sample in a precisely known strain state for each measurement.

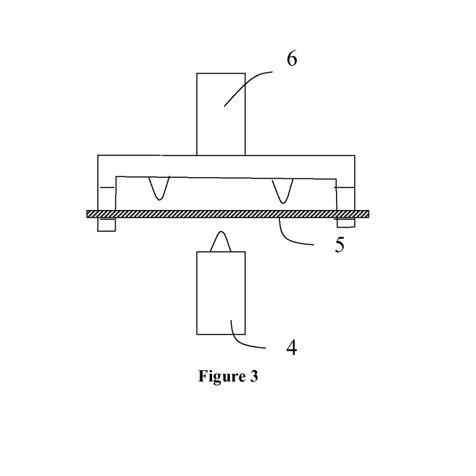

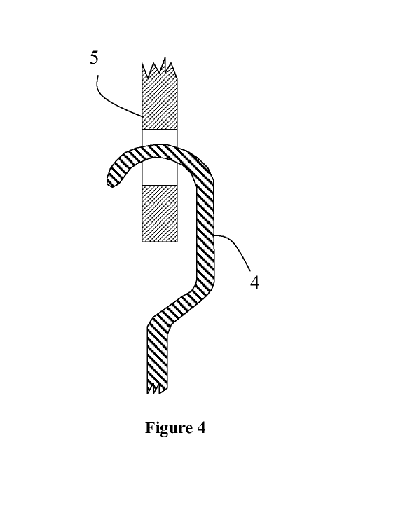

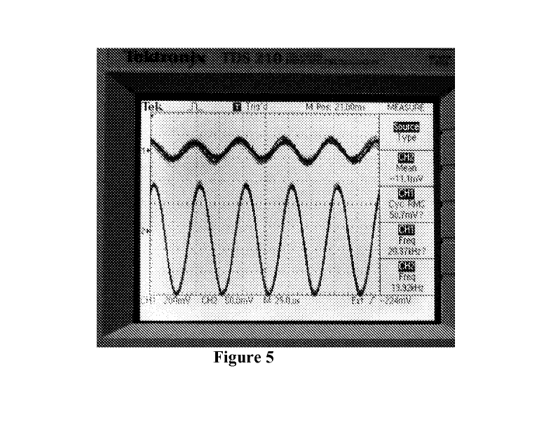

An alternate embodiment of the disclosure employs a sample platform for 3 point bending geometry as illustrated in FIG. 2. It is also noted that another embodiment for the 3 point bending geometry is possible by reversing the geometry, with the actuator carrying the single mid span contacting point and the stress transfer member carrying the sample as in FIG. 3. Similarly, a tensile testing geometry for the present disclosure can be realized in the embodiment of FIG. 4, where a hook-like strain actuator arm can be moved to engage the sample attached to the upper assembly only after the temperature equilibrium has been established. Many additional geometries and testing modes can be further contemplated, including, but not limited to, fiber and film fixtures, contact plates for viscous fluids, sample retaining fixtures for polymers undergoing cure, cantilever and simple shear geometries.

Yet another embodiment of the present disclosure is the addition of a manually operated, yet rigid linear stage to allow coarse movement of the actuator and the stress sensor. Further, if an actuator provides sufficient travel range with electronic signals, such as with long stoke piezo-electric stack transducers, it can be used to provide both static strain and dynamic excitation strain. Under this configuration, an isolation circuitry can be used to combine the DC (static) voltage drive and the wide frequency range AC drive signals. In some embodiments using a transducer with a relatively long stroke, both static deformation and dynamic excitation can be achieved electrically via proper coupling and impedance matching of the AC drive with DC from a high voltage power supply.

It is noted that while the main discussion has been the configuration where the stress transducer is above the sample which is in turn located above the strain actuator, the opposite configuration can be implemented with equal effectiveness. In such embodiments, the Z-axis stage and the actuator can be mounted on the upper part of the frame, while the stress transfer member is carrying the sample on its top surface and the stress transducer can be rigidly mounted on lower part of the frame. With each configuration, there are necessary minor adjustments for optimal operation, considered well within the capabilities of anyone having sufficient skills in the art.

Methods of the disclosure are suitable for high-frequency analysis. In some embodiments, a high frequency analysis is conducted at frequencies greater than about 1,000 Hz; greater than about 5,000 Hz; or greater than about 10,000 Hz.

Methods of the disclosure are suitable for analysis of samples of small size. In some embodiments, a sample is less than about 5 mm in the smallest dimension, less than about 2 mm in the smallest dimension, or less than about 1 mm in the smallest dimension.

Methods of the disclosure are also suitable for analysis of samples of widely different modulus. In some embodiments, the sample modulus range is between about 10 MPa and about 10 GPa. In some embodiments, the sample modulus range is between about 1 MPa and about 200 GPa.

In some embodiments, methods of the disclosure are performed at different temperatures to obtain temperature-dependent sample profiles. Methods of controlling temperature are well-known in the art, and it is understood that a person of ordinary skill in the art will be able to determine an appropriate temperature range at which to operate methods of the disclosure. In typical embodiments, the temperature will fall within the range from liquid nitrogen cryogenic temperatures of about −196° C. to about 500° C.

In some embodiments, the disclosure provides methods of measuring an inherent sample property termed zero strain state. As used herein, the term zero strain state refers to the quantity E* at zero strain, obtained, for example, by extrapolating data obtained using methods of the disclosure.

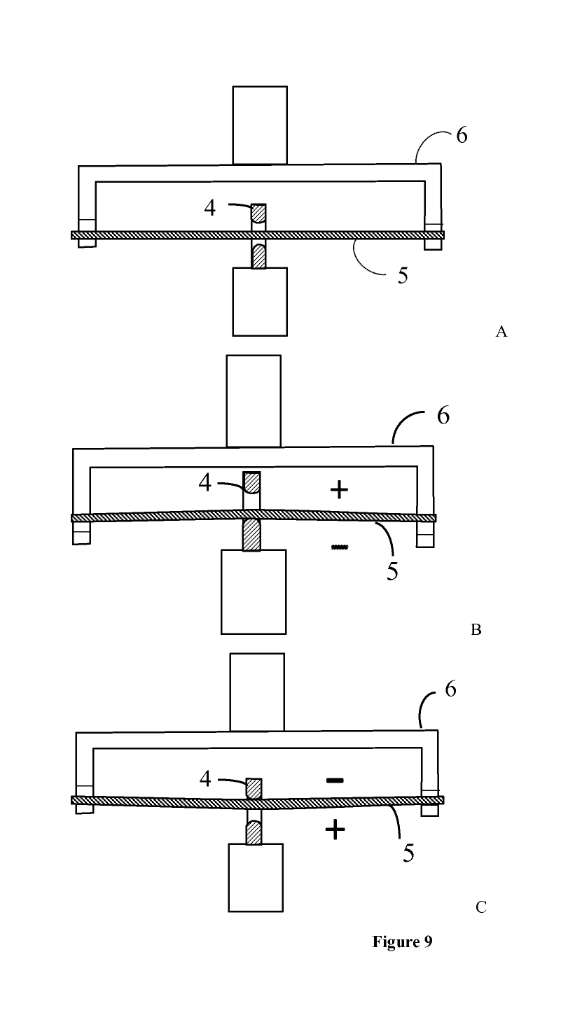

The present disclosure also provides apparatuses and methods for performing dynamic mechanical analysis using an actuator mechanism to maintain sample shape. An actuator mechanism for maintaining tubing shape for a pumping device is described in U.S. Pat. No. 5,151,019 (incorporated herein by reference in its entirety). An apparatus comprising an actuator mechanism is equipped with slots in both the sample carrier (connected to the stress sensor) and the displacement actuator. This ensures that at the beginning of each measurement cycle, the sample 5 is resting on the lower part of the sample carrier and the sample is not in contact with either the upper or lower contacting points of the displacement actuator 4 (FIG. 9A). As the Z axis positioner is elevated such that the lower contact point, and the upper slot surface of the sample carrier are all in contact (FIG. 9B), the sample is taken on a upward curvature with the upper surface in tension and lower surface in compression with the + and − signs indicating the stress conditions. The dynamic excitation of the displacement actuator then initiates and a measurement of the dynamic mechanical quantities taken. In the immediate following measurement cycle, the Z positioning is reversed, allowing the sample to take on the configuration depicted in FIG. 9C, with the lower surface in tension and upper surface in compression. In this alternating actuation sequence, any distortion in the sample from the previous cycle tends to be restored in the subsequent cycle. Thus, even after traversing a major Tg and substantial softening, through the alternating reversing actuation, the original sample shape can be substantially preserved and relative error free material quantities measured.

In some embodiments, the apparatuses can be used in the three point bending mode, wherein the center alternately contacts the upper and lower surfaces of the sample on alternate measurement cycles, thereby tending to maintain sample's original shape. As used herein, the sample's original shape refers to the shape and dimensions of the sample prior to the start of DMA.

### EXAMPLES

### Example 1

### Comparison of Variability Among Measurements of Diffeent Frequencies

A flexible Polyvinyl Chloride (PVC) sample of approximately 36% plasticizer content and rectangular cylinder in shape of about 2 mm by 3 mm in area and 6 mm in height was placed on the sample platform undergoing sinusoidal oscillation at different frequencies while the position and the oscillation amplitude was monitored with a non-contact inductive sensor of the disclosure.

Referring to FIG. 1, monitoring the outputs of the platform dynamic displacement and the load cell are sharply tuned filtering amplifies (tracking filters) slaved to the oscillating frequency and the tracking amplifier outputs displayed on a dual trace oscilloscope. At the start of the experiment, the sample was not in contact with the force coupling member and the load cell, and thus the output from the load cell amplifier tuned to the same oscillating frequency registered near zero output. The platform was then gradually advanced toward the load cell and when the sample first made contact with the force coupling member, a sharp, threshold signal was detected on the monitor. The position of the platform where threshold was detected was taken as the zero deformation point and, the platform was advanced under software control to a known position for a small but finite compressive displacement of the sample. At this displacement, readings were taken for the dynamic displacement, dynamic load and the phase angle between the two quantities. The above process was repeated for all frequencies and at different displacement (strain) levels of the sample and the resulting calculated dynamic modulus E* complied.

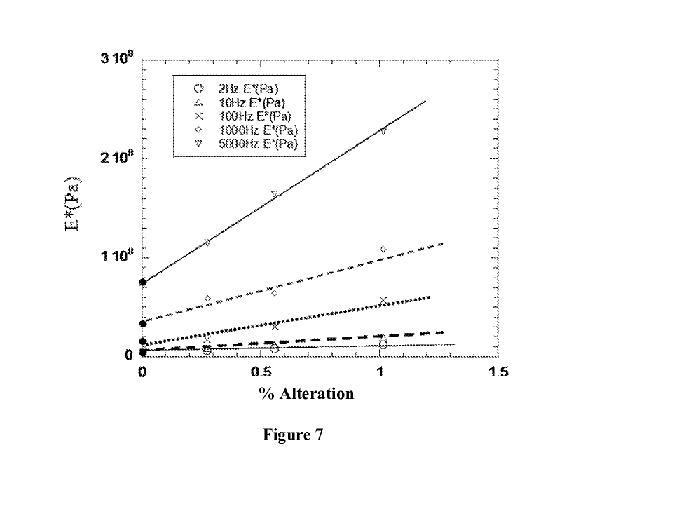

The data thus obtained (see FIG. 7) show the calculated dynamic modulus at various frequencies at different static strain levels. It is readily evident that the thus obtained modulus measurements steadily increase with frequency, consistent with theory on visco-elastic polymer materials. In addition, it was observed that, at lower frequencies, very little strain dependence is seen. However, at higher frequencies, unexpectedly, very pronounced strain dependence was evident. In addition, at these relatively low strain levels, the dynamic modulus at different strain levels allowed the extrapolation to zero to obtain E₀, defined as limiting modulus at zero strain. In this way, very accurate sample dimensions at various temperatures are determined, under intermittent minimal contact force. And the coefficient of thermal expansion (CTE) for this sample was determined to be about 3.7×10⁻⁴/° C., thus for this sample, as little as 15 degrees centigrade rise from room temperature would, if not properly taken into account, can cause large measurement errors at high frequencies.

To obtain comparative data, the same 36% plasticizer PVC sample was measured at 5 kHz on different dates, with the results shown in Table 1.

TABLE 1

| Run No. | 5 kHz E* (Pa) |
|---|---|
| 1 | 1.865 E8 |
| 2 | 2.721 E8 |
| 3 | 7.556 E8 |
| 4 | 4.984 E7 |
| 5 | 9.717 E7 |
| 6 | 1.033 E7 |
| 7 | 5.509 E8 |
| Av | 2.655 +− 2.55 E8 |

Without precise control of the static strain, the determined modulus values have data variation of 96% (standard deviation/mean).

In contrast, compressive strains are precisely known using methods of the disclosure, and the measurements demonstrated very little deviation (see FIG. 7). The data displayed in FIG. 7 exhibit a linear best-fit R² of 0.975 and average deviation from the predicted values of 0.216+-0.1%.

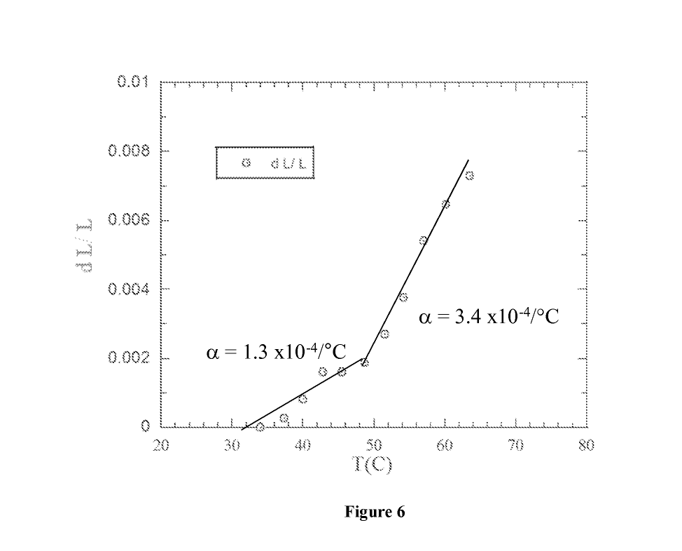

Since during the majority of the experimental time, the sample was not in contact on the apparatus with both the strain and stress transducers, its stress free linear expansion was accurately measured as the threshold position of the platform where dynamic force was first detected between different temperatures. In FIG. 6, the coefficient of thermal expansion for a 15% plasticized PVC thus determined is plotted, the distinct break in the coefficient of linear expansion is commonly designated as the glass transition temperature (Tg). Hence the determination of sample's coefficient of linear expansion (CTE) and any changes in functional behavior (e.g., thermal transitions including, but not limited to the glass transition (Tg)) serve as added detection quantities (see FIG. 6). As shown in FIG. 7, the extrapolated zero strain modulus quantity eliminated the ambiguity and data confusion frequently seen at high frequency data.

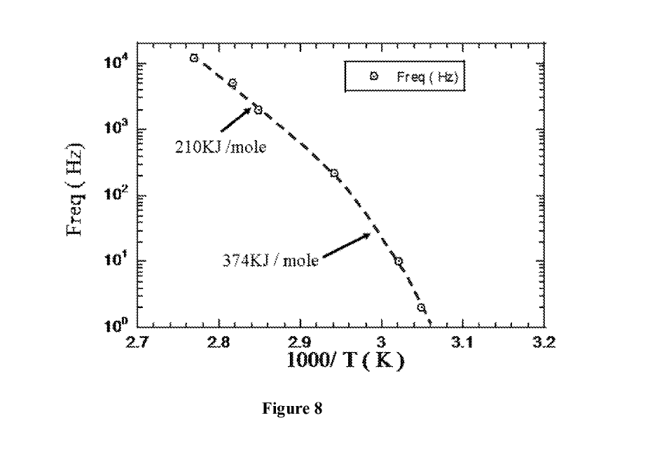

When the tan delta peak temperature at different frequencies for the 15% PVC sample was plotted against (1/T), where the T is the absolute temperature in FIG. 8, the activation enthalpy for the relaxation process can be obtained from the slope. As can be seen, there is slight reduction in the activation enthalpy at higher frequencies.

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments have been illustrated and described, it will be appreciated that various changes can be made without departing from the spirit and scope of the invention(s).

What is claimed is:

1. A method for dynamic mechanical analysis of a sample comprising:
a) contacting the sample to a dynamic displacement transducer;
b) subjecting the sample to controlled variation of one or more environmental variables;
c) subjecting the sample to a dynamic displacement produced by the dynamic displacement transducer;
d) contacting the sample to a stress transducer, such that the sample experiences a strain;
e) taking a measurement representative of the sample's response to the strain;
f) releasing the contact between the sample and the stress transducer; and
g) iterating steps b) through f), thereby obtaining a series of measurements across a range of said one or more environmental variables.

2. The method of claim 1, wherein contacting the sample to a stress transducer comprises:
a) bringing the sample in contact with the stress transducer; and
b) advancing the sample towards the stress tranducer by an additional finite distance

3. The method of claim 2, wherein the finite distance is 1%, 2%, 3%, 4%, 5%, 6%, 7%, 8%, 9%, or 10% of the sample length.

4. The method of claim 1, wherein the contact is released by changing the position of the sample relative to the stress transducer.

5. The method of claim 1, wherein each of the one or more environmental variables is selected from the group consisting of: temperature, time, electric field, and magnetic field.

6. The method of claim 5, wherein one of the one or more environmental variables is temperature.

7. The method of claim 6, further comprising calculating a coefficient of thermal expansion of the sample.

8. The method of claim 1, further comprising measuring the sample length, after step d.

9. The method of claim 1, wherein the sample is not in contact with both the dynamic displacement transducer and the stress transducer during the controlled variation of one or more environmental variables.

10. The method of claim 1, wherein the sample undergoes a phase change or chemical transformation during the controlled variation of one or more environmental variables.

11. An apparatus for dynamic mechanical analysis comprising:
a) means for controlling variation of one or more environmental variables;
b) a dynamic displacement transducer;
c) a stress transducer;
d) measuring means for detecting a signal from the stress transducer representative of the response of a sample;
e) sample holding means, permitting contact between the sample and one, both, and neither of the dynamic displacement transducer and stress transducer; and
f) computer-implemented means for modulating contact between the sample and the stress transducer for each measurement cycle.

12. The apparatus of claim 11, wherein the stress transducer and sample holding means are arranged in a three point bending geometry with the stress transducer positioned above the sample holding means.

13. The apparatus of claim 11, wherein the stress transducer and sample holding means are arranged in a three point bending geometry with the stress transducer positioned below the sample holding means.

14. The apparatus of claim 11, wherein the stress transducer and sample holding means are arranged in a tensile testing geometry.

15. A method for dynamic mechanical analysis of a sample comprising:
a) contacting the sample to a stress transducer;
b) subjecting the sample to controlled variation of one or more environmental variables;
c) contacting the sample to a dynamic displacement transducer coupled to an actuator;
d) subjecting the sample to a dynamic displacement produced by the dynamic displacement transducer, such that the sample experiences a strain;
e) taking a measurement representative of the sample response to the strain;
f) releasing the contact between the sample and the dynamic displacement transducer; and
g) iterating steps b) through f), thereby obtaining a series of measurements across a range of said one or more environmental variables;
wherein, for each measurement cycle, motion of the actuator reverses the direction of net force exerted by the the dynamic displacement transducer on the sample, thereby tending to restore distortion of the sample caused by contact with the dynamic displacement transducer from the previous cycle.

16. An apparatus for dynamic mechanical analysis comprising:
a) means for controlling variation of one or more environmental variables;
b) a dynamic displacement transducer capable of contacting a sample from two opposing sides;
c) a stress transducer;
d) measuring means for detecting a signal from the stress transducer representative of the response of a sample;
e) sample holding means, permitting contact between the sample and one, both, and neither of the dynamic displacement transducer and stress transducer;
f) computer-implemented means for modulating contact between the sample and the dynamic displacement transducer for each measurement cycle; and
g) means to reverses the direction of net force exerted by the the dynamic displacement transducer on the sample, for each cycle, thereby tending to restore distortion of the sample caused by contact with the dynamic displacement transducer from the previous cycle.
